(19) United States
(12) Patent Application Publication
(10) Pub. No.: US 2011/0220381 A1
(43) Pub. Date: Sep. 15, 2011

(54) ELECTRICAL APPLIANCE, IN PARTICULAR HAND-HELD POWER TOOL

(76) Inventors: Andreas FRIESE, Pfalzgrafenweiler (DE); Andreas Kynast, Stuttgart (DE); Andreas Schlegel, Leinfelden-Echterdingen (DE)

(21) Appl. No.: 13/044,051

(22) Filed: Mar. 9, 2011

(30) Foreign Application Priority Data
Mar. 9, 2010 (DE) 10 2010 002 702.2

(51) Int. Cl. B25F 5/02; F16J 15/02

(52) U.S. Cl. 173/217; 277/628

(57) ABSTRACT

The invention relates to an electrical appliance, in particular a hand-held power tool, having an appliance housing, a circuitry substrate that is situated in the appliance housing and equipped with components, and sealing elements for preventing the influx of dirt into the region of the circuitry substrate. According to the invention, the sealing elements seal a subregion of the circuitry substrate off from other regions inside the appliance housing.

### CROSS-REFERENCE TO RELATED APPLICATION

This application is based on German Patent Application 10 2010 002 702.2 filed on Mar. 9, 2010.

### BACKGROUND OF THE INVENTION

1. Field of the Invention

The invention relates to an electrical appliance, in particular a hand-held power tool.

2. Description of the Prior Art

An electrical appliance of this kind known from the prior art has, for example, a housing that is composed of two housing shells inside which are accommodated the drive unit of the electrical appliance and the electrical circuitry for the drive unit. Examples of this include drills, grinders, or similar hand-held power tools. In such electrical appliances, it is also known to provide a sealing element embodied in the form of ribs inside the housing shells in order to prevent the penetration of dust or other impurities since such impurities make it impossible to ensure reliable function of the electrical appliance over a long service life. It is also known from the prior art to seal a drive motor using flexible seal produced with an injection-molding process and inserted into the housing shells.

### OBJECT AND SUMMARY OF THE INVENTION

Based on the above-cited prior art, the object of the invention is to modify an electrical appliance in such a way that protects only those regions that are situated on a circuitry substrate and must for functional or optical reasons be protected from the influx of dust, dirt, or the like.

This object is attained in an electrical appliance according to the invention. The invention is based on the idea of situating the sealing elements so that they are operatively connected to the circuitry substrate such that the sealing elements protect only a subregion of the circuitry substrate from the influence of dust, dirt, or the like. On the one hand, this fulfills the desired functionality in the region sealed off by the sealing elements; on the other hand, however, it permits other regions of the circuitry substrate that are equipped, for example, with heat-emitting components to continue to be cooled, for example by means of a blower unit or through the influx of air from the surroundings.

In particular, it is possible for the components of the circuitry substrate to include at least one optical element that is visible from the outside, in particular a light-emitting element, and for the optical element to be situated in the subregion of the circuitry substrate that is sealed off by the sealing elements. In view of the positioning of the optical element inside the sealed subregion, the optical element—e.g. in the form of a light-emitting diode that can be seen from the outside for example by a user and that indicates the operating or voltage state of the hand-held power tool—is always visible with its full illuminating power, i.e. does not become covered with dirt.

According to a preferred design implementation of the invention, the sealing elements include a flexible sealing element that is situated in contact with a stationary counterpart element. In this case, the flexible sealing element is in particular able to compensate for component tolerances inside the electrical appliance, thus enabling a simplified assembly and relatively inexpensive manufacturability of the sealing elements.

In order to position the flexible sealing element inside the housing, according to a proposed preferred embodiment, the sealing element is fastened to a first support element that is situated on an inner wall of the appliance housing. As a result, the sealing element can be integrated into the housing of the electrical appliance during a pre-assembly process of the electrical appliance and removing the circuitry substrate from the housing does not also require removal of the sealing element.

In this case, it is particularly preferable if the first support element is embodied of one piece with the appliance housing, in particular by being injection-molded onto the appliance housing. This has the particular advantage that with a conventional embodiment of the appliance housing in the form of an injection-molded plastic component, the mold of the first support element can already be integrated into or taken into account in the mold for manufacturing the appliance housing so that embodying the first support element essentially incurs no additional costs.

According to another proposal, the first support element has a recess for accommodating the sealing element in a form-locked manner. This enables a simple installation of the sealing element and, in the event of damage, a simple replacement of the sealing element on the support element.

In order to enable a simple installation of the counterpart element that does not require any additional assembly effort after insertion of the circuitry substrate into the housing, according to another proposal, a counterpart element is situated on the side of the circuitry substrate oriented toward the sealing element; the sealing element rests against the counterpart element in a sealed fashion.

In this case, it is in particular possible for both the sealing element and the counterpart element to be embodied as strip-shaped. As a rule, such an embodiment permits a uniform contact pressure between the sealing element and the counterpart element and a flat, leakproof contact of the counterpart element against the sealing element.

To enable an embodiment that is simple from a production engineering standpoint, in which the circuitry substrate is encompassed by a casting compound, in another proposed design implementation of the invention, the circuitry substrate is situated in an in particular bowl-like casting housing that is filled with a casting compound on the side oriented toward the sealing element, the casting housing is situated in stationary fashion in the appliance housing, the counterpart element is situated in the region of the casting compound, and the counterpart element protrudes from the casting compound at least with a segment that is operatively connected to the sealing element.

The invention will be better understood and further objects and advantages thereof will become more apparent from the ensuing detailed description of preferred embodiment taken in conjunction with the drawings.

### BRIEF DESCRIPTION OF THE DRAWINGS

FIG. 1 is a longitudinal section through a subregion of an electrical appliance according to the invention; and

FIG. 2 is a perspective, partially cutaway view of the subregion according to FIG. 1.

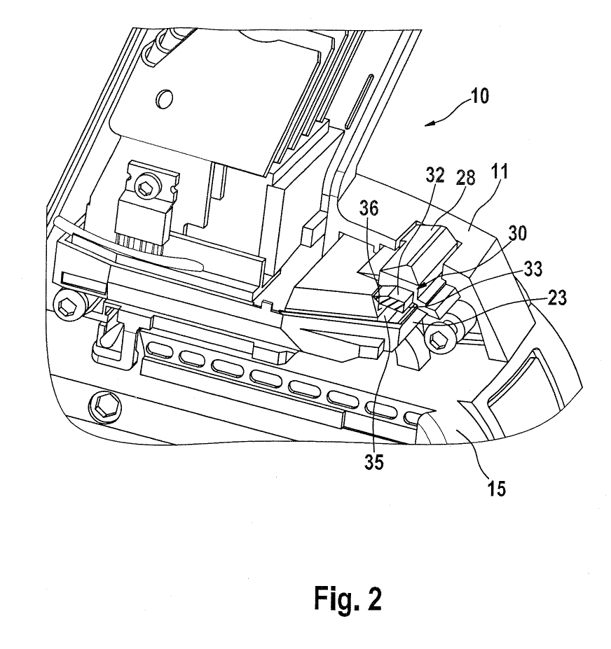

### DESCRIPTION OF THE PREFERRED EMBODIMENT

In the figures, parts that are the same or function in the same manner are provided with identical reference numerals.

The figures show a subregion of an electrical appliance 10 according to the invention, in particular a hand-held power tool. For example, the electrical appliance 10 can be a drill that is known in the building trades or some other hand-held power tool.

The electrical appliance 10 has a housing 11 that is composed, for example, of two housing shells that are not shown in greater detail. The housing 11 or more precisely, the housing shells, is/are in particular composed of plastic and manufactured using the injection-molding process. The components of the electrical appliance 10 are contained inside the housing 11 or housing shells.

In the lower region of the housing 11, the drawing shows an accommodating region 14 for accommodating an in particular replaceably embodied energy storage device, e.g. in the form of a battery pack 15. The drawing also shows a circuitry substrate embodied in the form of a circuit board 17 of the electrical appliance 10 on which are accommodated a multitude of components, e.g. a heat-emitting component 18 and an optical component in the form of a light-emitting diode 20. The light-emitting diode 20 can, for example, indicate the operating state or operational readiness of the electrical appliance 10 or some other function of the electrical appliance 10; the light-emitting diode 20 is visible from the outside, i.e. by a user, via a transparently embodied section 21 in the housing 11, e.g. by means of a corresponding insert in the housing 11.

In an electrical appliance 10 of the above-described kind, dirt or dust can get into the housing 11, for example through the accommodating region 14 or through ventilation slots or the like. With the presence of a (cooling) blower, there is a risk of dirt being scattered into other regions in the housing 11. In addition, certain regions inside the electrical appliance 10, e.g. the region of the heat-emitting component 18, must be cooled or must at least be provided with the possibility of a certain amount of air exchange.

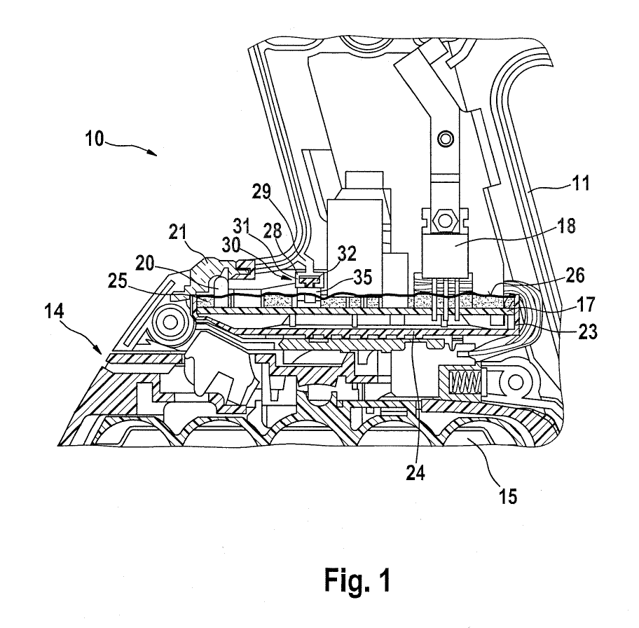

The circuitry substrate or circuit board 17 is accommodated in a bowl-like casting bowl 23 whose bottom 24 is situated on the side of the electrical appliance 10 oriented toward the accommodating region 14. The casting bowl 23 is filled with a casting compound 25 in a region above the circuit board 17. The casting compound 25 in particular serves to provide a protected positioning of the components on the circuit board, for example of the component 18 and the light-emitting diode 20. For example, the casting compound 25 absorbs vibrations or other mechanical or thermal strains. After the casting process, the casting compound 25 has a surface 26 whose precise form and height can fluctuate at least slightly from one electrical appliance 10 to the next for production-related reasons. The electrical appliance 10 is especially embodied so that the subregion of the circuit board 17 accommodating the light-emitting diode 20 is protected from the influx of dust, dirt, or the like in order to thus assure a clear visibility of the light-emitting diode 20 from the outside over the entire operating or service life of the electrical appliance 10. To this end, a first support element 28 is situated on the inner wall of the housing 11, the one housing half, or both housing halves. The first support element 28 is in particular embodied by being injection-molded onto the housing 11; the first support element 28 extends perpendicular to the plane of the drawing in FIG. 1, over the entire inside width and height of the housing 11.

The first support element 28 has a strut 29 that transitions into an accommodating region 30 with a recess 31 embodied in the form of a sliding block groove. A strip-like flexible sealing element 32, e.g. in the form of a rubber sealing lip possibly composed of multiple parts, can be inserted into the recess 31 in a form-locked fashion. On the side oriented toward the casting compound 25, the sealing edge 33 of the sealing element 32 cooperates with a likewise strip-shaped counterpart element 35. The contact surface 36 of the counterpart element 35 here protrudes out from the surface 26 of the casting compound 25; the counterpart element 35 is dimensioned so that taking into account all production-related tolerances, the contact surface 36 is always situated above the surface 26 of the casting compound 25. In particular, the counterpart element 35, which can be embodied for example in the form of an injection-molded plastic part, is fastened to the circuit board 17, e.g. is screwed, soldered, or welded to it.

In the assembly of the individual parts of the electrical appliance 10, first the sealing element 32 is connected in form-locked fashion to the first support element 28. Then the casting bowl 23—which is provided with the casting compound 25 and contains the electrical and electronic components, the heat-emitting component 18, and the light-emitting diode 20 of the electrical appliance 10—is mounted in a corresponding recess of the housing 11 and attached to the housing 11. As a result, the sealing element 32 comes into an operative connection with the contact surface 36 of the counterpart element 35. As a result, the region of the light-emitting diode 20 is protected from the influx of dirt, dust, or the like that is present inside the housing 11. The locally limited sealing of only the light-emitting diode 20, however, permits the heat-emitting component 18, for example, to continue to participate in an air exchange with the surroundings, thereby permitting it to be optimally cooled.

The above-described electrical appliance 10 can be modified or changed in a variety of ways without going beyond the scope of the concept of the invention. This invention is composed of a protected arrangement of at least one subregion of the electronics or circuitry substrate and of the electrical appliance 10 in such a way that the protected subregion can perform a reliable function over the service life of the electrical appliance 10.

The foregoing relates to preferred exemplary embodiment of the invention, it being understood that other variants and embodiments thereof are possible within the spirit and scope of the invention, the latter being defined by the appended claims.

1. An electrical appliance, in particular a hand-held power tool, comprising:
an appliance housing;
a circuitry substrate that is situated in the appliance housing and equipped with components; and
sealing means for preventing dirt from entering into a region of the circuitry substrate, the sealing means sealing a subregion of the circuitry substrate off from other regions inside the appliance housing.

2. The electrical appliance according to claim 1, wherein the components of the circuitry substrate include at least one optical element that is visible from outside the appliance housing, in particular a light-emitting element, the optical element being situated in the subregion of the circuitry substrate sealed off by the sealing means.

3. The electrical appliance according to claim 1, wherein the sealing means include a

4. The electrical appliance according to claim 2, wherein the sealing means includes a flexible sealing element that is situated in contact with a stationary counterpart element.

5. The electrical appliance according to claim 3, wherein the sealing element is fastened to a first support element that is situated on an inner wall of the appliance housing.

6. The electrical appliance according to claim 4, wherein the sealing element is fastened to a first support element that is situated on an inner wall of the appliance housing.

7. The electrical appliance according to claim 5, wherein the first support element is embodied of one piece with the appliance housing, in particular by being injection-molded onto the appliance housing.

8. The electrical appliance according to claim 6, wherein the first support element is embodied of one piece with the appliance housing, in particular by being injection-molded onto the appliance housing.

9. The electrical appliance according to claim 5, wherein the first support element has a recess for accommodating the sealing element in a form-locked manner.

10. The electrical appliance according to claim 6, wherein the first support element has a recess for accommodating the sealing element in a form-locked manner.

11. The electrical appliance according to claim 7, wherein the first support element has a recess for accommodating the sealing element in a form-locked manner.

12. The electrical appliance according to claim 8, wherein the first support element has a recess for accommodating the sealing element in a form-locked manner.

13. The electrical appliance according to claim 1, wherein the sealing means includes a counterpart element situated on a side of the circuitry substrate oriented toward the sealing element and the sealing element rests against the counterpart element in a sealed fashion.

14. The electrical appliance according to claim 12, wherein the sealing means includes a counterpart element situated on a side of the circuitry substrate oriented toward the sealing element and the sealing element rests against the counterpart element in a sealed fashion.

15. The electrical appliance according to claim 13, wherein the sealing element and the counterpart element are embodied as strip-shaped.

16. The electrical appliance according to claim 14, wherein the sealing element and the counterpart element are embodied as strip-shaped.

17. The electrical appliance according to claim 13, wherein the circuitry substrate is situated in an in particular bowl-like casting housing that is filled with a casting compound on the side of the circuitry substrate oriented toward the sealing element, the casting housing is situated in stationary fashion in the appliance housing, the counterpart element is situated in a region of the casting compound, and the counterpart element protrudes from the casting compound at least with a contact surface that comes into an operative connection with the sealing element.

18. The electrical appliance according to claim 15, wherein the circuitry substrate is situated in an in particular bowl-like casting housing that is filled with a casting compound on the side of the circuitry substrate oriented toward the sealing element, the casting housing is situated in stationary fashion in the appliance housing, the counterpart element is situated in a region of the casting compound, and the counterpart element protrudes from the casting compound at least with a contact surface that comes into an operative connection with the sealing element.

19. The electrical appliance according to claim 17, wherein the counterpart element is fastened to the circuitry substrate.

20. The electrical appliance according to claim 18, wherein the counterpart element is fastened to the circuitry substrate.
